(19) United States
(12) Patent Application Publication
(10) Pub. No.: US 2026/0223015 A1
(43) Pub. Date: Jul. 30, 2026

(54) TECHNIQUES FOR REDUCED MAXIMUM POWER REDUCTION FOR UPLINK CARRIER AGGREGATION

(71) Applicant: Lenovo (United States) Inc., Morrisville, NC (US)

(72) Inventor: Colin Frank, Park Ridge, IL (US)

(21) Appl. No.: 19/038,568

(22) Filed: Jan. 27, 2025

(51) Int. Cl. H04W 52/36; H04W 36/00

(52) U.S. Cl. CPC H04W 52/367; H04W 36/00692

(57) ABSTRACT

Various aspects of the present disclosure relate to techniques for reduced maximum power reduction for uplink carrier aggregation. An apparatus is configured to determine one or more emissions requirements for a transmission channel for a user equipment (UE), the UE configured for transmission on a plurality of carriers using carrier aggregation (CA); define a maximum power reduction (MPR) for the UE based on the one or more emissions requirements for transmission on a single carrier of the plurality of carriers; and communicate in accordance with the MPR.

### TECHNICAL FIELD

The present disclosure relates to wireless communications, and more specifically to techniques (e.g., methods, designs) for reduced maximum power reduction for uplink carrier aggregation (CA).

### BACKGROUND

A wireless communications system may include one or multiple network communication devices, such as base stations, which may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A user equipment (UE) for wireless communication is described. The UE may be configured to, capable of, or operable to determine one or more emissions requirements for a transmission channel for a UE, the UE configured for transmission on a plurality of carriers using CA, define a maximum power reduction (MPR) for the UE based on the one or more emissions requirements for transmission on a single carrier of the plurality of carriers, and communicate in accordance with the MPR.

A method for wireless communication performed by a UE. The method may be configured to determine one or more emissions requirements for a transmission channel for a UE, the UE configured for transmission on a plurality of carriers using CA, define an MPR for the UE based on the one or more emissions requirements for transmission on a single carrier of the plurality of carriers, and communicate in accordance with the MPR.

A processor for wireless communication is described. The processor may be configured to, capable of, or operable to determine one or more emissions requirements for a transmission channel for a UE, the UE configured for transmission on a plurality of carriers using CA, define an MPR for the UE based on the one or more emissions requirements for transmission on a single carrier of the plurality of carriers, and communicate in accordance with the MPR.

A network equipment (NE) for wireless communication is described. The NE may be configured to, capable of, or operable to configure a UE for contiguous carrier aggregation for a plurality of carriers, determine an allowed MPR for the UE comprising an inner MPR region that is expanded relative to a single carrier MPR region for single carrier emissions requirements, determine a lower bound on a maximum configured power for a resource block allocation based on the allowed MPR, the resource block allocation within at least one of the plurality of carriers, and communicate the lower bound on the maximum configured power for the resource block allocation.

A method for wireless communication performed by a NE. The method may be configured to configure a UE for contiguous carrier aggregation for a plurality of carriers, determine an allowed MPR for the UE comprising an inner MPR region that is expanded relative to a single carrier MPR region for single carrier emissions requirements, determine a lower bound on a maximum configured power for a resource block allocation based on the allowed MPR, the resource block allocation within at least one of the plurality of carriers, and communicate the lower bound on the maximum configured power for the resource block allocation.

A processor for wireless communication is described. The processor may be configured to, capable of, or operable to configure a UE for contiguous carrier aggregation for a plurality of carriers, determine an allowed MPR for the UE comprising an inner MPR region that is expanded relative to a single carrier MPR region for single carrier emissions requirements, determine a lower bound on a maximum configured power for a resource block allocation based on the allowed MPR, the resource block allocation within at least one of the plurality of carriers, and communicate the lower bound on the maximum configured power for the resource block allocation.

### BRIEF DESCRIPTION OF THE DRAWINGS

FIG. 1 illustrates an example of a wireless communications system, in accordance with aspects of the present disclosure.

FIG. 2 illustrates an example of the frequency regions in which the emissions requirements apply for single carrier operation, in accordance with aspects of the present disclosure.

FIG. 3A illustrates an example of possible configurations of an extended channel bandwidth, in accordance with aspects of the present disclosure.

FIG. 3B illustrates other examples of extended channel bandwidths, in accordance with aspects of the present disclosure.

FIG. 4 illustrates an example of a user equipment (UE) in accordance with aspects of the present disclosure.

FIG. 5 illustrates an example of a processor in accordance with aspects of the present disclosure.

FIG. 6 illustrates an example of a network equipment in accordance with aspects of the present disclosure.

FIG. 7 illustrates a flowchart of a method in accordance with aspects of the present disclosure.

FIG. 8 illustrates a flowchart of a method in accordance with aspects of the present disclosure.

### DETAILED DESCRIPTION

Wireless communications networks, such as fifth generation (5G) new radio (NR), can coexist peacefully with adjacent cellular bands and sometimes in the same spectrum as other wireless communications systems such as Wi-Fi, CBRS (citizens broadband radio service), military and satellite services. In such networks, a UE's uplink coverage may be increased by reducing the UE's allowed MPR. As used herein, MPR may refer to the amount by which the maximum power level of a 5G network can be reduced. An example scenario may include the reduction of MPR for intra-band uplink (UL) CA.

It has been observed that a large margin exists between the current MPR requirements and the measured power back-off for intra-band CA for both frequency range 1 (FR1) and frequency range 2 (FR2). The MPR is defined based primarily on the configuration of band combination rather than based on the active UL component carriers (CCs) scheduled. Due to the much larger MPR allowed for UL CA, the transmission power capability for UL CA or dual-carrier (DC) transmission DC is not fully utilized compared to the single CC transmission. As a result, it has been proposed to improve the MPR definition for the NR intra-band UL CA or DC.

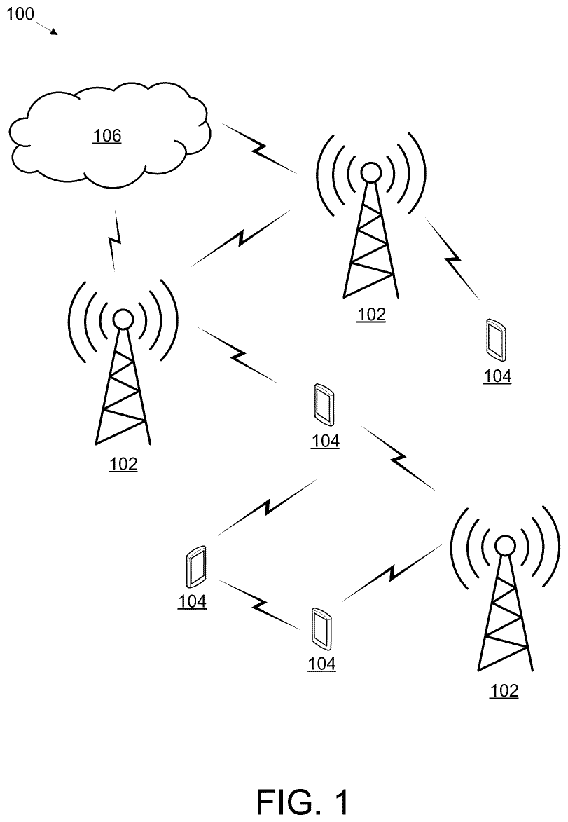

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one embodiment, the system 100 shown in FIG. 1 is configured to, capable or, or operable to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

In one embodiment, when a UE configures its maximum power P_{c,max}, the UE is allowed a maximum power reduction to meet emissions constraints. The emissions constraints may include the adjacent channel leakage ratio (ACLR) requirement, the in-band emissions requirement, the spectrum emissions mask (SEM), and the spurious emissions requirement.

The in-band emissions requirement applies for resource blocks (RBs) within the UE transmission bandwidth that are not used for transmission by the UE. The purpose of the in-band emissions constraint is to avoid interfering with other UE's transmitting using these other RBs. The purpose of the constraints on the spectrum emissions mask and the spurious emissions domain are to avoid interfering with users in other channels and bands.

It is noted that separate ACLR, in-band, SEM, and spurious emissions requirements are defined for single carrier transmission and for CA. The sets of emissions requirements from TS 38.101-1 (incorporated herein by reference) are provided below:

| Parameter | Unit | Limit | | Applicable Frequencies |
|---|---|---|---|---|
| General | dB | max{−25 − 10 · log₁₀(N_{RB}/L_{CRB}), 20 · | | Any non-allocated (NOTE 2) |
| | | log₁₀ EVM − 3 − 5 · (\|Δ_{RB}\| − 1)/L_{CRB}, −57 | | |
| | | dBm + 10 log₁₀(SCS/15 kHz) − P̅_̅{̅R̅B̅}̅} | | |
| IQ Image | dB | −28 | Output power > 10 dBm | Image frequencies |
| | | −25 | 0 ≤ Output power ≤ 10 dBm | (NOTE 3) |
| Carrier | dBc | −28 | Output power > 10 dBm | Carrier leakage frequency |
| leakage | | −25 | 0 dBm ≤ Output power ≤ 10 dBm | (NOTE 4, 5) |
| | | −20 | −30 dBm ≤ Output power ≤ 0 dBm | |
| | | −10 | −40 dBm ≤ Output power < −30 dBm | |

NOTE 1:
An in-band emissions combined limit is evaluated in each non-allocated RB. For each such RB, the minimum requirement is calculated as the higher of P̅_̅{̅R̅B̅}̅ − 30 dB and the power sum of all limit values (General, IQ Image or Carrier leakage) that apply. P̅_̅{̅R̅B̅}̅ is defined in NOTE 10. The limit is evaluated in each non-allocated RB.
(NOTE 2):
The measurement bandwidth is 1 RB and the limit is expressed as a ratio of measured power in one non-allocated RB to the measured average power per allocated RB, where the averaging is done across all allocated RBs
(NOTE 3):
The applicable frequencies for this limit are those that are enclosed in the reflection of the allocated bandwidth, based on symmetry with respect to the carrier leakage frequency, but excluding any allocated RBs.
(NOTE 4):
Exceptions to the general limit are allowed for up to two contiguous non-allocated RBs. The measurement bandwidth is 1 RB and the limit is expressed as a ratio of measured power in the non-allocated RB to the measured total power in all allocated RBs.
(NOTE 5):
The applicable frequencies for this limit are those that are enclosed either in the RB containing the carrier leakage frequency, or in the two RBs immediately adjacent to the carrier leakage frequency but excluding any allocated RB. Carrier leakage frequency is indicated by the UE as described in clause 6.4A.2.1.0. When only one uplink carrier is activated, the applicable LO leakage frequency follow definition in clause 6.4.2.
NOTE 6:
L_{CRB} is the Transmission Bandwidth (see clause 5.3) not exceeding └N_{RB}/2 − 1┘.
NOTE 7:
N_{RB} is the Transmission Bandwidth Configuration (see clause 5.3) of the component carrier with RBs allocated.
NOTE 8:
EVM is the limit specified in Table 6.4.2.1-1 for the modulation format used in the allocated RBs.
NOTE 9:
Δ_{RB} is the starting frequency offset between the allocated RB and the measured non-allocated RB (e.g. Δ_{RB} = 1 or Δ_{RB} = −1 for the first adjacent RB outside of the allocated bandwidth).
NOTE 10:
P̅_̅{̅R̅B̅}̅ is an average of the transmitted power over 10 sub-frames normalized by the number of allocated RBs, measured in dBm.

Minimum requirements for in-band emissions (allocated component carrier)

| Parameter | | | | Applicable |
|---|---|---|---|---|
| description | Unit | Limit (NOTE 1) | | Frequencies |
| General | dB | max{−25 − 10 · log₁₀(N_{RB}/L_{CRB}), 20 · | | Any non- |
| | | log₁₀ EVM − 3 − 5 · (\|Δ_{RB}\| − 1)/L_{CRB}, −57 | | allocated |
| | | dBm + 10 log₁₀ (SCS/15 kHz) − P̅_̅{̅R̅B̅}̅} | | (NOTE 2) |
| IQ Image | dB | −28 | Image frequencies when output | Image |
| | | | power > 10 dBm | frequencies |
| | | −25 | Image frequencies when output | (NOTES 2, 3) |
| | | | power ≤ 10 dBm | |
| Carrier | dBc | −28 | Output power > 10 dBm | Carrier leakage |
| leakage | | −25 | 0 dBm ≤ Output power ≤ 10 dBm | frequency |
| | | −20 | −30 dBm ≤ Output power < 0 dBm | (NOTES 4, 5) |
| | | −10 | −40 dBm ≤ Output power < −30 dBm | |

NOTE 1:
An in-band emissions combined limit is evaluated in each non-allocated RB. For each such RB, the minimum requirement is calculated as the higher of P̅_̅{̅R̅B̅}̅ − 30 dB and the power sum of all limit values (General, IQ Image or Carrier leakage) that apply. P̅_̅{̅R̅B̅}̅ is defined in NOTE 10.
NOTE 2:
The measurement bandwidth is 1 RB and the limit is expressed as a ratio of measured power in one non-allocated RB to the measured average power per allocated RB, where the averaging is done across all allocated RBs. For pi/2 BPSK with Spectrum Shaping, the limit is expressed as a ratio of measured power in one non-allocated RB to the measured power in the allocated RB with highest PSD.
NOTE 3:
The applicable frequencies for this limit are those that are enclosed in the reflection of the allocated bandwidth, based on symmetry with respect to the carrier leakage frequency, but excluding any allocated RBs.
NOTE 4:
The measurement bandwidth is 1 RB and the limit is expressed as a ratio of measured power in one non-allocated RB to the measured total power in all allocated RBs.
NOTE 5:
The applicable frequencies for this limit depend on the parameter txDirectCurrentLocation in UplinkTxDirectCurrent IE, and are those that are enclosed either in the RB containing the carrier leakage frequency, or in the two RBs immediately adjacent to the carrier leakage frequency but excluding any allocated RB.
NOTE 6:
L_{CRB} is the Transmission Bandwidth (see clause 5.3).
NOTE 7:
N_{RB} is the Transmission Bandwidth Configuration (see clause 5.3).
NOTE 8:
EVM is the limit specified in Table 6.4.2.1-1 for the modulation format used in the allocated RBs.
NOTE 9:
Δ_{RB} is the starting frequency offset between the allocated RB and the measured non-allocated RB (e.g. Δ_{RB} = 1 or Δ_{RB} = −1 for the first adjacent RB outside of the allocated bandwidth.
NOTE 10:
P̅_̅{̅R̅B̅}̅ is an average of the transmitted power over 10 sub-frames normalized by the number of allocated RBs, measured in dBm.
NOTE 11:
For almost contiguous allocations defined in clause 6.2.2, L_{CRB} = N_{RB}_{_{—}}_{alloc} + N_{RB}_{_{—}}_{gap} with no in-gap emission requirement.

### Requirements for In-Band Emissions

The emissions constraints for ACLR, in-band, SEM, and spurious emissions are as follows:

| | ACLR/Measurement bandwidth |
|---|---|
| CA ACLR | 30 dB |
| CA Measurement bandwidth | Nominal channel space + |
| (NOTE 1) | MBW_{ACLR, low}/2 + MBW_{ACLR, high}/2 |
| Adjacent channel centre | +BW_{Channel}_{_{—}}_{CA}/−BW_{Channel}_{_{—}}_{CA} |
| frequency offset (in MHz) | |
| Difference between ACLR | MBW_{shift} = (MBW_{ACLR}_{_{—}}_{CA} − |
| MBW center and F_{c, low} | MBW_{ACLR, low})/2 |

NOTE 1:
MBW_{ACLR, low} and MBW_{ACLR, high} are the single-channel ACLR measurement bandwidths specified for channel bandwidths BW_{channel(low)} and BW_{channel(high)} in 6.5.2.4.1, respectively.

### General Requirements for Intra-Band Contiguous CA ACLR

| | ACLR/Measurement bandwidth |
|---|---|
| CA ACLR | 31 dB |
| CA Measurement bandwidth | Nominal channel space + |
| (NOTE 1) | MBW_{ACLR, low}/2 + MBW_{ACLR, high}/2 |
| Adjacent channel centre | +BW_{Channel}_{_{—}}_{CA}/−BW_{Channel}_{_{—}}_{CA} |
| frequency offset (in MHz) | |
| Difference between ACLR | MBW_{shift} = (MBW_{ACLR}_{_{—}}_{CA} − |
| MBW center and F_{c, low} | MBW_{ACLR, low})/2 |

NOTE 1:
MBW_{ACLR, low} and MBW_{ACLR, high} are the single-channel ACLR measurement bandwidths specified for channel bandwidths BW_{channel(low)} and BW_{channel(high)} in 6.5.2.4.1, respectively.

### Requirements for Intra-Band Contiguous CA ACLR Power Class 2

| Channel | (MHz) | 3, 5, 10, 15, 20, 25, | 60, 70, 80, 90, 100 |
|---|---|---|---|
| bandwidth | | 30, 35, 40, 45, 50 | |
| REF_SCS | (kHz) | 15 | 30 |
| NR ACLR | (MHz) | MBW = REF_SCS*(12*N_{RB} + 1)/1000 | |
| measurement | | | |
| bandwidth | | | |

NOTE:
“N_{RB}” in the formula is the maximum transmission bandwidth configuration as defined in Table 5.3.2-1.

### NR ACLR Measurement Bandwidth

| | Power | Power | Power | Power |
|---|---|---|---|---|
| | class 1 | class 1.5 | class 2 | class 3 |
| NR ACLR | 37 dB | 31 dB | 31 dB | 30 dB |

NOTE 1:
Void

### NR ACLR Requirement

| | Spectrum | |
|---|---|---|
| Δf_{OOB} | emission | |
| (MHz) | limit(dBm) | MBW(MHz) |
| ±0-1 | −13 | Min(0.01*BWchannel_CA, 0.4) |
| ±1-5 | −10 | 1 MHz |
| ±5-BW_{channel}_{_{—}}_{CA} | −13 | 1 MHz |
| ±BW_{channel}_{_{—}}_{CA}- | −25 | 1 MHz |
| BW_{channel}_{_{—}}_{CA} + 5 | | |

### General NR CA Spectrum Emission Mask

| | Channel bandwidth (MHz)/ | | | | |
|---|---|---|---|---|---|
| | Spectrum emission limit (dBm) | | | | |
| Δf_{OOB} | | | 10, 15, 20, 25, | 50, 60, 70, | Measurement |
| (MHz) | 3 | 5 | 30, 35, 40, 45 | 80, 90, 100 | bandwidth |
| ±0-1 | −13 | −13 | −13 | | 1% of channel BW |
| ±0-1 | | | | −24 | 30 kHz |

| | | | | |
|---|---|---|---|---|
| ±1-5 | −10 | −10 | −10 | 1 MHz |
| ±5-6 | −25 | −13 | | |
| ±6-10 | | −25 | | |
| ±5-BW_{Channel} | | | −13 | |
| ±BW_{Channel}- | | | −25 | |
| (BW_{Channel} + 5) | | | | |

### General NR Spectrum Emission Mask

For intra-band contiguous CA the spurious emission limits apply for the frequency ranges that are more than FOOB (MHz) in the table below from the edge of the aggregated channel bandwidth. For frequencies ΔfOOB greater than FOOB, the spurious emission requirements in the table below are applicable. For power class 2 intra-band contiguous carrier aggregation, the spurious emissions is measured as the sum from both UE transmit antenna connectors when UE indicates support for dualPA-Architecture information element.

| Aggregated Channel | |
|---|---|
| bandwidth | OOB boundary F_{OOB} (MHz) |
| BW_{Channel}_{_{—}}_{CA} | BW_{Channel}_{_{—}}_{CA} + 5 |

### Boundary Between Out of Band and Spurious Emission Domain for Intra-Band Contiguous Carrier Aggregation

| Channel bandwidth | OOB boundary F_{OOB} (MHz) |
|---|---|
| 3 | 6 |
| 5, 10, 15, 20, 25, 30, 35, 40, | BW_{Channel} + 5 |
| 45, 50, 60, 70, 80, 90, 100 | |

### Boundary Between NR Out of Band and General Spurious Emission Domain

| | Maximum | Measurement | | |
|---|---|---|---|---|
| Frequency Range | Level | bandwidth | | NOTE |
| 9 kHz ≤ f < 150 kHz | −36 dBm | 1 | kHz | |
| 150 kHz ≤ f < 30 MHz | −36 dBm | 10 | kHz | |
| 30 MHz ≤ f < 1000 MHz | −36 dBm | 100 | kHz | |
| 1 GHz ≤ f < 12.75 GHz | −30 dBm | 1 | MHz | 4 |
| | −25 dBm | 1 | MHz | 3 |
| 12.75 GHz ≤ f < 5^{th} harmonic | −30 dBm | 1 | MHz | 1 |
| of the upper frequency edge | | | | |
| of the UL operating band in | | | | |
| GHz | | | | |
| 12.75 GHz < f < 26 GHz | −30 dBm | 1 | MHz | 2 |

NOTE 1:
Applies for Band for which the upper frequency edge of the UL Band is greater than 2.55 GHz and less than or equal to 5.2 GHz
NOTE 2:
Applies for Band that the upper frequency edge of the UL Band more than 5.2 GHz
NOTE 3:
Applies for Band n41, CA configurations including Band n41, and EN-DC configurations that include n41 specified in clause 5.2B of TS 38.101-3 [3] when NS_04 is signalled.
NOTE 4:
Does not apply for Band n41, CA configurations including Band n41, and EN-DC configurations that include n41 specified in subclause 5.2B of TS 38.101-3 [3] when NS_04 is signalled.

### Requirement for General Spurious Emissions Limits

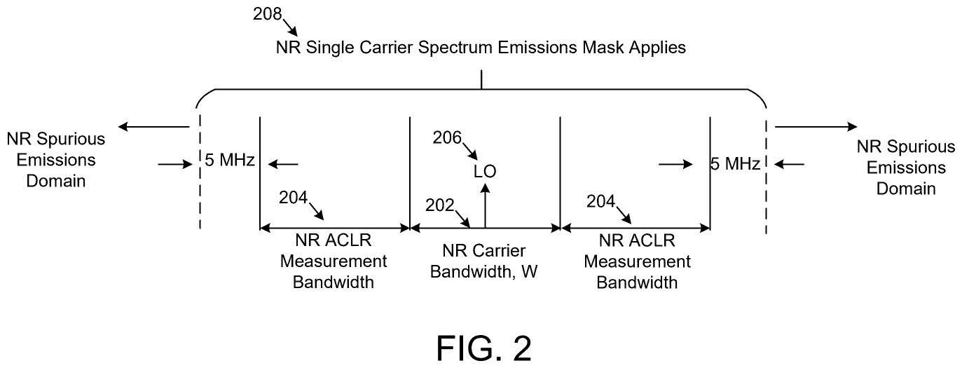

FIG. 2 illustrates an example of the frequency regions in which the emissions requirements apply for single carrier operation, in accordance with aspects of the present disclosure. In the depicted embodiment, the frequency regions are divided into an NR Carrier Bandwidth, W 202, and NR ACLR Measurement Bandwidths 204 on each side of W 202. A single local oscillator (LO) 206 is used for a single carrier and an NR Single Carrier Spectrum Emissions Mask 208 is applied.

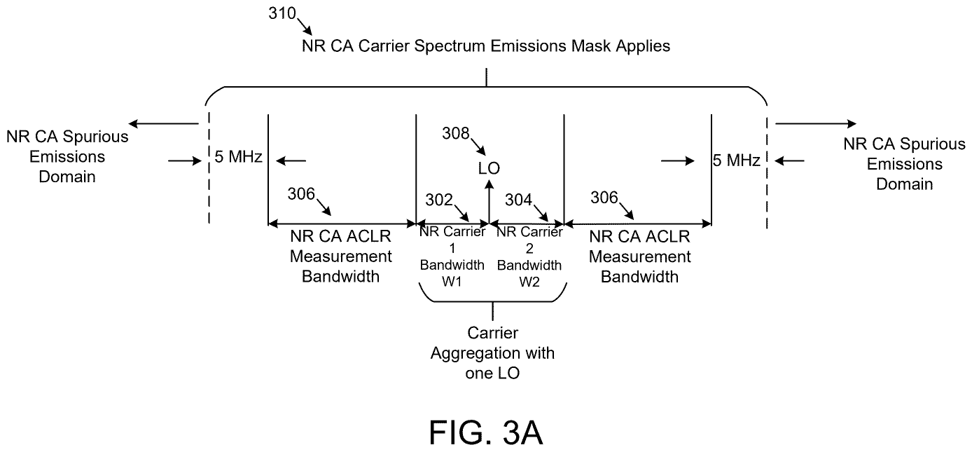

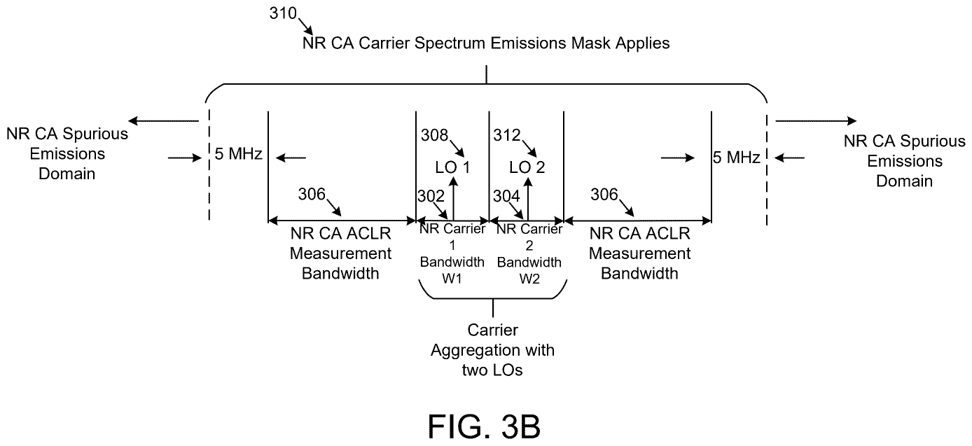

FIGS. 3A and 3B illustrates an example of the frequency regions in which the emissions requirements apply for carrier aggregation, in accordance with aspects of the present disclosure. Note that FIGS. 3A and 3B show two different radio implementations with the first using a single local oscillator for both carriers, and the second using a separate oscillator for each of the two carriers.

In FIG. 3A, the frequency regions are divided into an NR Carrier 1 Bandwidth, W1 302, NR Carrier 2 Bandwidth, W2 304, and NR CA ACLR Measurement Bandwidths 306 on each side of W1 302 and W2 304. A single LO 308 is used for CA and an NR CA Carrier Spectrum Emissions Mask 310 is applied.

In FIG. 3B, the frequency regions are divided into an NR Carrier 1 Bandwidth, W1 302, NR Carrier 2 Bandwidth, W2 304, and NR CA ACLR Measurement Bandwidths 306 on each side of W1 302 and W2 304. Two LOs 308, 312 are used for CA and an NR CA Carrier Spectrum Emissions Mask 310 is applied.

The MPR that is allowed to meet emissions requirements in FIG. 2 for single carrier operation is shown in the tables below for power class 3 and power class 2, respectively:

MPR (dB)

| | Edge RB | Outer RB | Inner RB |
|---|---|---|---|
| Modulation | allocations | allocations | allocations |

| | | | | |
|---|---|---|---|---|
| DFT-s- | Pi/2 BPSK | ≤3.5¹ | ≤1.2¹ | ≤0.2¹ |
| OFDM | | ≤0.5^{2,3} | ≤0.5² | 0^{2,4} |
| | Pi/2 BPSK w | ≤0.5^{2,3} | 0² | 0^{2,4} |
| | Pi/2 BPSK | | | |
| | DMRS | | | |

| | QPSK | ≤1 | 0⁵ |
|---|---|---|---|
| | 16 QAM | ≤2 | ≤1 |
| | 64 QAM | ≤2.5 | |
| | 256 QAM | ≤4.5 | |
| CP- | QPSK | ≤3 | ≤1.5 |
| OFDM | 16 QAM | ≤3 | ≤2 |

| | |
|---|---|
| 64 QAM | ≤3.5 |
| 256 QAM | ≤6.5 |

NOTE 1:
Applicable for UE operating in TDD mode with Pi/2 BPSK modulation and UE indicates support for UE capability powerBoosting-pi2BPSK and if the IE powerBoostPi2BPSK is set to 1 and 40% or less slots in radio frame are used for UL transmission for bands n40, n41, n77, n78 and n79. The reference power of 0 dB MPR is 26 dBm.
NOTE 2:
Applicable for conditions where note 1 does not apply.
NOTE 3:
For 3 MHz channel bandwidth the Pi/2 BPSK edge allocation MPR is 1 dB
NOTE 4:
For a UE indicating support for UE capability [powerBoostRel18] or [powerBoostTSRel18] and if the IE [powerBoostPi2BPSKRel18] is set to 1, the reference power is increased by [ΔP_{PowerBoost} − ΔP_{PowerClass}]
NOTE 5:
For a UE indicating support for UE capability [powerBoostRel18] or [powerBoostTSRel18] and if the IE [powerBoostQPSKRel18] is set to 1, the reference power is increased by [ΔP_{PowerBoost} − ΔP_{PowerClass}]

### MPR for Power Class 3

| | | MPR (dB) | | |
|---|---|---|---|---|
| | | Edge RB | Outer RB | Inner RB |
| Modulation | | allocations | allocations | allocations |
| DFT-s- | Pi/2 BPSK | ≤3.5 | ≤0.5 | 0¹ |
| OFDM | QPSK | ≤3.5 | ≤1 | 0² |
| | 16 QAM | ≤3.5 | ≤2 | ≤1 |

| | | |
|---|---|---|
| 64 QAM | ≤3.5 | ≤2.5 |

| | 256 QAM | ≤4.5 | | |
|---|---|---|---|---|
| CP- | QPSK | ≤3.5 | ≤3 | ≤1.5 |
| OFDM | 16 QAM | ≤3.5 | ≤3 | ≤2 |

| | |
|---|---|
| 64 QAM | ≤3.5 |
| 256 QAM | ≤6.5 |

NOTE 1:
Applicable for a UE indicating support for UE capability [powerBoostRel18] or [powerBoostRel18TS] and if the IE [powerBoostPi2BPSKRel18] is set to 1. The reference power is increased by [ΔP_{PowerBoost} − ΔP_{PowerClass}]
NOTE 2:
Applicable for a UE indicating support for UE capability [powerBoostRel18] or [powerBoostRel18TS] and if the IE [powerBoostQPSKRel18] is set to 1. The reference power is increased by [ΔP_{PowerBoost} − ΔP_{PowerClass}]

### MPR for Power Class 2

The MPR that is allowed to meet the emissions requirements carrier aggregation shown in FIGS. 3A and 3B is shown below for power class 3, power class 2, and power class 2 with dual Tx:

| | | MPR for bandwidth | | MPR for bandwidth | |
|---|---|---|---|---|---|
| | | class B(dB) | | class C(dB) | |
| Modulation | | inner | outer | inner | outer |
| DFT-s- | Pi/2 | 1.0 | 3.5 | 2.5 | 7 |
| OFDM | BPSK | | | | |
| | QPSK | 1.0 | 3.5 | 2.5 | 7 |
| | 16QAM | 1.5 | 3.5 | 2.5 | 7 |
| | 64QAM | 3.0 | 4.0 | 5 | 7 |
| | 256QAM | 5.5 | 6.0 | 7 | 7.5 |
| CP- | QPSK | 2.0 | 4.0 | 3.5 | 8 |
| OFDM | 16QAM | 2.5 | 4.0 | 3.5 | 8 |
| | 64QAM | 3.5 | 4.0 | 5 | 8 |
| | 256QAM | 6.5 | 6.5 | 7 | 8 |

### Contiguous RB Allocation for Power Class 3

| | | MPR for bandwidth | | MPR for bandwidth | |
|---|---|---|---|---|---|
| | | class B(dB) | | class C(dB) | |
| Modulation | | inner | Outer¹ | inner | outer |
| DFT-s- | Pi/2 | 2.0 | 4.0¹ | 2.5 | 7 |
| OFDM | BPSK | | | | |
| | QPSK | 2.0 | 4.0¹ | 2.5 | 7 |
| | 16QAM | 2.5 | 4.0¹ | 2.5 | 7 |
| | 64QAM | 3.0 | 4.5¹ | 5 | 7 |
| | 256QAM | 5.5 | 6.0 | 7 | 7.5 |
| CP- | QPSK | 2.5 | 5.0¹ | 3.5 | 8 |
| OFDM | 16QAM | 3.0 | 5.0¹ | 3.5 | 8 |
| | 64QAM | 3.5 | 5.0¹ | 5 | 8 |
| | 256QAM | 6.5 | 6.5 | 7 | 8 |

NOTE 1:
When 1 RB or 2 RB are allocated at the lower edge of lowest CC or upper edge of upper CC, MPR for outer is 5.5 dB.

### Contiguous RB Allocation for Power Class 2

| | | MPR for bandwidth | | MPR for bandwidth | |
|---|---|---|---|---|---|
| | | class B(dB) | | class C(dB) | |
| Modulation | | inner | Outer¹ | inner | outer |
| DFT-s- | Pi/2 | 3.0 | 5.0¹ | 3.5 | 8 |
| OFDM | BPSK | | | | |
| | QPSK | 3.0 | 5.0¹ | 3.5 | 8 |
| | 16QAM | 3.5 | 5.0¹ | 3.5 | 8 |
| | 64QAM | 4.0 | 5.5¹ | 6 | 8 |
| | 256QAM | 6.5 | 7.0 | 8 | 8.5 |
| CP- | QPSK | 3.0 | 5.5¹ | 4.0 | 8.5 |
| OFDM | 16QAM | 3.5 | 5.5¹ | 4.0 | 8.5 |
| | 64QAM | 4.0 | 5.5¹ | 5.5 | 8.5 |
| | 256QAM | 7.0 | 7.0 | 7.5 | 8.5 |

NOTE 1:
When 1 RB or 2 RB are allocated at the lower edge of lowest CC or upper edge of upper CC, MPR for outer is 5.5 dB.
NOTE 2:
UE indicating TxD supported

Contiguous RB Allocation for Power Class 2 with Dual Tx2

From the foregoing tables, the following observations can be made:

(i) For power class 3, the MPR allowed for single carrier operation with CP-OFDM is 0.5 to 1 dB less than for CA for bandwidth class B, and 1.5 to 5 dB less than for CA for bandwidth class C. For power class 3, the MPR allowed for single carrier operation with DFT-s-OFDM is 0.5 to 2.5 dB less than for CA for bandwidth class B, and 1.5 to 6 dB less than for CA bandwidth class C.

(ii) For power class 2, the MPR allowed for single carrier operation with CP-OFDM is 0 to 2 dB less than for CA for bandwidth class B, and 0.5 to 5 dB less than for CA for bandwidth class C. For power class 2, the MPR allowed for single carrier operation with DFT-s-OFDM is 0 to 6 dB less than for CA for bandwidth class B, and 1.5 to 6 dB less than for CA bandwidth class C.

(iii) For power class 2, the MPR allowed for single carrier operation with CP-OFDM is 0.5 to 2.5 dB less than for CA for bandwidth class B with dual Tx, and 1 to 5.5 dB less than for CA for bandwidth class C with dual Tx. For power class 2, the MPR allowed for single carrier operation with DFT-s-OFDM is 1.5 to 4.5 dB less than for CA for bandwidth class B with dual Tx, and 2.5 to 7.5 dB less than for CA bandwidth class C with dual Tx.

Based on these observations, the MPR that is allowed for CA is in general significantly larger than the MPR that is allowed for single carrier transmission, and thus it would be preferable to use the single carrier MPR, when possible, in order for the UE to be able to transmit more power.

When the UE is configured for CA, the UE is allowed to use the MPR defined for CA when transmitting even if it is only allocated RBs on one of the two carriers. Because the MPR allowed for single carrier transmission can be much less than the MPR defined for CA, it would be preferable if the UE was limited to the single carrier MPR when transmitting RBs from a single carrier even when the UE is configured for CA. However, there is some question as to whether a UE configured for CA and transmitting RBs on only one of the two carriers can meet the emissions requirements using the MPR defined for single carrier transmission.

Whether a UE that is configured for CA but transmitting RBs on a single carrier can meet emissions requirements using the MPR defined for single carrier transmission depends on two factors:

(i) Which emissions requirements apply for a UE configured for CA when it transmits RBs for a single carrier? Do the single carrier emissions requirements apply as in FIG. 2, or do the CA emissions requirements apply as in FIGS. 3A and 3B?

(ii) Does the UE implement CA with a single power amplifier (PA) and thus a single local oscillator (LO) in the middle of the aggregated bandwidth as in FIG. 3A, or does the UE implement CA with two PAs and two LOs as in FIG. 3B?

In the case that the single carrier emissions requirements apply and the UE implements CA using a single PA with a single LO in the center of the aggregated channel bandwidth, the in-phase quadrature (I/Q) image (with respect to the location of the LO) of the RBs transmitted on one carrier will fall on the second carrier and may cause some single carrier emissions requirements, such as the spectrum emissions mask to be failed.

Conversely, if the CA emissions requirements apply, then the I/Q image of the RBs from an LO placed in the middle of the aggregated bandwidth will fall within an allowed exception of the in-band emissions requirements for the LO I/Q image of the transmitted RBs. As a result, if the CA emissions requirements are applied when the UE transmits RBs for a single carrier, the single carrier MPR should be sufficient to meet all emissions requirements even if a single PA is used and the LO is centered in the middle of the aggregated bandwidth. In the alternative implementation in which CA is implemented with two PAs and two LOs, with each LO centered within its corresponding component carrier (CC), the emissions when transmitting RBs on a single carrier is the same as for single carrier transmission, and the single carrier MPR can be applied regardless of whether the single carrier or CA emissions requirements are applied.

In summary, if the CA emissions requirements are applied when a UE configured for CA transmits RBs on a single CC, then the MPR defined for single carrier transmission can be used. Conversely, if the single carrier emissions requirements are applied when a UE configured for CA transmits RBs on a single carrier, then the MPR defined for single carrier can be used if the UE uses separate PAs with separate LOs for the two carriers (as in FIG. 3B), but the MPR defined for CA is allowed if the UE uses one PA for both carriers with the LO centered in the aggregated bandwidth (as in FIG. 3A). To allow the single carrier MPR for both the one PA and two PA implementations and thus increase the transmit power available for the uplink when the UE is configured for CA, the CA emissions requirements should be applied when the UE configured for CA is transmitting on RBs for a single carrier.

If the CA emissions requirements are applied when the UE configured for CA is transmitting RBs from a single carrier, then the “Inner” RB region in the single carrier MPR tables can be redefined since the bandwidth of the adjacent carrier is now in-band from an emissions perspective as shown in FIGS. 3A and 3B. That is, the in-band emissions requirements now apply to the aggregated bandwidth of the two carriers and the ACLR requirements no longer apply in the frequency range occupied by the carrier on which the UE is not transmitting RBs.

The Inner RB region may be defined (e.g., in TS-38.101-1, incorporated herein by reference) such that the second order intermodulation products of the RB allocation are contained within the UE channel bandwidth, excluding the guard band. Let N_{RB} denote the maximum number of RB's that can be transmitted within the UE channel bandwidth and let the RB indices be indexed in the interval [0, N_{RB}−1]. Let L_{CRB} denote the number of allocated RBs in a contiguous RB allocation. The Inner RB allocations may be defined such that the first RB of the allocation RB_{Start} satisfies RB_{Start,Low}≤RB_{Start}≤RB_{Start,High} where RB_{Start,Low}=max(1, floor(L_{CRB}/2)) and RB_{Start,High}=N_{RB}−RB_{Start,Low}−L_{CRB}.

When the UE is configured for CA, transmits RBs on one carrier, and the CA emissions requirements apply, the Inner RB allocation region can be expanded. For instance, let W1 and W2 denote the bandwidths of the left and right carriers as indicated in FIGS. 3A and 3B. Here, the first carrier is the lower frequency carrier (to the left in FIGS. 3A and 3B), and the second carrier is the higher frequency carrier (to the right in FIGS. 3A and 3B). Let N_{RB,1} and N_{RB,2} denote the maximum number of RBs corresponding to the first and second carriers, respectively. Here, it is assumed that the two carriers use the same subcarrier spacing. If not, then when determining the inner region for the first carrier, the number of RBs for the second carrier N_{RB,2} can be converted to the corresponding number of RBs for the first carrier by multiplying N_{RB,2} by the ratio of the subcarrier spacing of the first carrier to the subcarrier spacing of the second carrier. Similarly, when determining the inner region for the second carrier, the number of RBs for the first carrier N_{RB,1} can be converted to the corresponding number of RBs for the second carrier by multiplying N_{RB,1} by the ratio of the subcarrier spacing of the second carrier to the SCS of the first carrier.

If the UE is configured for CA and transmits RBs on the first carrier, then the inner region for the first carrier can be modified if the CA emissions requirements are applied. Let L_{CRB,1} denote the number of contiguously allocated RBs on the first carrier, and let RB_{Start,1} denote the first RB of the allocation. The inner, outer, and edge regions for a contiguous RB allocation of L_{CRB} RBs can be redefined.

For instance, for the first carrier, the Inner RB allocations are defined such that the first RB of the allocation RB_{Start} satisfies RB_{Start,Low,1}≤RB_{Start}≤RB_{Start,High,1} where RB_{Start,Low,1}=max(1, floor (L_{CRB}/2)) and RB_{Start,High,1}=min (min (N_{RB,1}−L_{CRB}−floor(L_{CRB}/2), N_{RB,1}−2)+N_{RB,2}, N_{RB,1}−L_{CRB}). In the case that N_{RB,2}≥ceil(N_{RB,1}/2), then RB_{Start_High}=N_{RB,1}−L_{CRB}.

An Edge RB allocation is the one for which RB_{Start}=0, and L_{CRB}≤2 RBs except for PC1 UE supporting bands other than for n14. The RB allocation is an Outer RB allocation for all other allocations which are not an Inner RB allocation or Edge RB allocation.

Alternatively, the inner, outer, and edge regions can be defined where N_{RB,Extended}=N_{RB,1}+N_{RB,2} and the following parameters are defined to specify valid RB allocation ranges for Outer and Inner RB allocations—RB_{Start,Low,Extended}=max(1, floor(L_{CRB}/2)) where max( ) indicates the largest value of all arguments and floor(x) is the greatest integer less than or equal to x and RB_{Start,High,Extended}=N_{RB,Extended}−RB_{Start,Low,Extended}−L_{CRB}. The RB allocation is an Inner RB allocation if the following condition is met RB_{Start,Low,Extended}≤RB_{Start}≤RB_{Start,High,Extended}.

An edge allocation is one for which RB_{Start}=0 and L_{CRB}≤2 RBs except for a PC1 UE supporting bands other than n14. The RB allocation is an Outer RB allocation for all other allocations which are not an Inner RB allocation or Edge RB allocation.

If the UE is configured for CA and transmits RBs on the second carrier, then the inner region for the second carrier can be modified if the CA emissions requirements are applied. Let L_{CRB} denote the number of contiguously allocated RBs on the second carrier and let RB_{Start} denote the first RB of the allocation. The inner, outer, and edge regions for a contiguous RB allocation of L_{CRB} RBs can now be redefined. For the second carrier, the Inner RB allocations are defined such that the first RB of the allocation RB_{Start} satisfies RB_{Start,Low,2}≤RB_{Start}≤RB_{Start,High,2} where RB_{Start,Low,2}=max(max (1, floor(L_{CRB}/2))−N_{RB,1}, 0) and RB_{Start,High,2}=min(N_{RB,2}−L_{CRB}−floor(L_{CRB}/2), N_{RB,2}−2).

In the case that N_{RB,1}≥ceil(N_{RB,2}/2), RB_{Start,Low,2}=0. An edge RB allocation is an allocation for which RB_{Start,2}=N_{RB}−1 and L_{CRB}=1 or for which RB_{Start,2}=N_{RB}−2 and L_{CRB}=2 except for a PC1 UE supporting other bands than n14. The RB allocation is an Outer RB allocation for all other allocations which are not an Inner RB allocation or Edge RB allocation.

Alternatively, the inner, outer, and edge regions can be defined where N_{RB,Extended}=N_{RB,1}+N_{RB,2} and the following parameters are defined to specify valid RB allocation ranges for Outer and Inner RB allocations-RB_{Start,Low,Extended}=max(1, floor(L_{CRB}/2)) where max( ) indicates the largest value of all arguments and floor(x) is the greatest integer less than or equal to x and RB_{Start,High,Extended}=N_{RB,Extended}−RB_{Start,Low,Extended}−L_{CRB}. The RB allocation is an Inner RB allocation if the following condition is met RB_{Start,Low,Extended}≤RB_{Start}+N_{RB,1}≤RB_{Start,High,Extended}.

An edge allocation is one for which RB_{Start}+N_{RB,1}=RB_{Start,High,Extended}−1 and L_{CRB}=1 RB or for which RB_{Start}+N_{RB,1}=RB_{Start,High,Extended}−2 and L_{CRB}=2 RB except for a PC1 UE supporting bands other than n14. The RB allocation is an Outer RB allocation for all other allocations which are not an Inner RB allocation or Edge RB allocation.

In summary, if the UE is configured for uplink CA and transmits RBs on one of the carriers, then the MPR Inner region can be expanded as discussed above. The advantage of expanding the inner MPR region is that for any modulation type (DFT-s-OFDM or CP-OFDM), and any modulation order (Pi/2 BPSK, QPSK, 16QAM, 64QAM, 256QAM), the MPR allowed for the inner region is less than or equal to the MPR allowed for the outer or edge region.

In is noted that the MPR is used in the definition of P_{CMAX_L,f,c}, which is the lower bound on the maximum configured power of the UE. The UE is allowed to set its configured maximum output power P_{CMAX,f,c} for carrier f of serving cell c in each slot. The configured maximum output power P_{CMAX,f,c} is set within the following bounds P_{CMAX_L,f,c}≤P_{CMAX,f,c}≤P_{CMAX_H,f,c} with P_{CMAX_L,f,c}=MIN{P_{EMAX,c}−ΔT_{C,c}, (P_{PowerClass}−ΔP_{PowerClass}+ΔP_{PowerBoost})−MAX(MAX(MPR(+ΔMPR_{c}, A-MPR_{c})+ΔT_{IB,c}+ΔT_{C,c}+ΔT_{RxSRS}, P-MPR_{c})} and P_{CMAX_H,f,c}=MIN{P_{EMAX,c}, P_{PowerClass}−ΔP_{PowerClass}+ΔP_{PowerBoost}}.

For the gNB to properly schedule the UE uplink transmission, it needs knowledge of the maximum power that the UE can transmit for a given RB allocation so that it can assign the appropriate modulation and coding rate for the uplink transmission. With knowledge of the MPR that can be taken by the UE for a given RB allocation, the gNB can determine the minimum value P_{CMAXL,f,c} of the UEs maximum configured power P_{CMAX,f,c}, and this information is used by the gNB scheduler both when selecting the RB allocation for the UE and the corresponding modulation and coding rate.

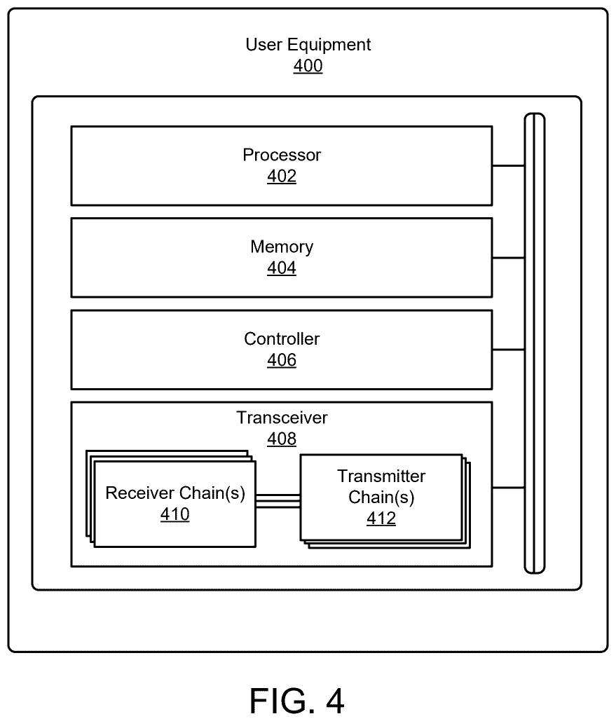

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 to cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein.

In one embodiment, the UE 400 is configured to determine one or more emissions requirements for a transmission channel for a UE, the UE configured for transmission on a plurality of carriers using CA, define an MPR for the UE based on the one or more emissions requirements for transmission on a single carrier of the plurality of carriers, and communicate in accordance with the MPR.

In one embodiment, the emissions requirements are for contiguous CA transmission and wherein the emissions requirements apply when transmitting on the single carrier of the plurality of carriers. In one embodiment, the UE 400 is configured to identify a set of resource block allocations for which an inner MPR applies, wherein an MPR region for the inner MPR is expanded relative to an MPR region for the single carrier for single carrier emissions requirements.

In one embodiment, the single carrier of the plurality of carriers is a lower frequency uplink carrier. In one embodiment, the single carrier of the plurality of carriers is an upper frequency uplink carrier. In one embodiment, the UE 400 is configured to apply the MPR in response to using separate PAs (with separate LOs) for the plurality of carriers.

In one embodiment, channel bandwidth for determining the emissions requirements for the UE is aggregated from channel bandwidth of at least two carriers of the plurality of carriers and in-band emissions requirements apply to the aggregated bandwidth of the at least two carriers.

In one embodiment, the at least two carriers of the plurality of carriers use the same subcarrier spacing. In one embodiment, the at least two carriers of the plurality of carriers use different subcarrier spacing.

In one embodiment, an inner MPR region of the aggregated bandwidth comprises a number of resource blocks determined based on a ratio of the subcarrier spacing of a first carrier of the at least two carriers and the subcarrier spacing of a second carrier of the at least two carriers. In one embodiment, an inner MPR region for the UE is expanded based on the aggregated bandwidth of the at least two carriers.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receiving the signal over the air or wireless medium. The receiver chain 410 may include at least one amplifier (e.g., a low-noise amplifier (LNA)) configured to amplify the received signal. The receiver chain 410 may include at least one demodulator configured to demodulate the received signal and obtain the transmitted data by reversing the modulation technique applied during transmission of the signal. The receiver chain 410 may include at least one decoder for decoding and processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

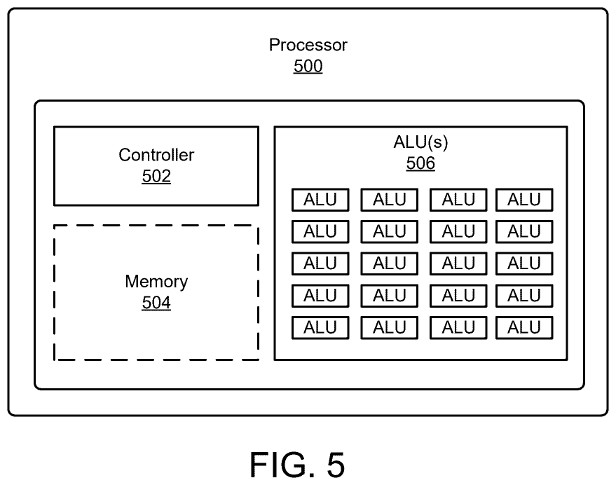

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. In one embodiment, the processor 500 is configured to determine one or more emissions requirements for a transmission channel for a UE, the UE configured for transmission on a plurality of carriers using CA, define an MPR for the UE based on the one or more emissions requirements for transmission on a single carrier of the plurality of carriers, and communicate in accordance with the MPR.

In one embodiment, the emissions requirements are for contiguous CA transmission and wherein the emissions requirements apply when transmitting on the single carrier of the plurality of carriers. In one embodiment, the processor 500 is configured to identify a set of resource block allocations for which an inner MPR applies, wherein an MPR region for the inner MPR is expanded relative to an MPR region for the single carrier for single carrier emissions requirements.

In one embodiment, the single carrier of the plurality of carriers is a lower frequency uplink carrier. In one embodiment, the single carrier of the plurality of carriers is an upper frequency uplink carrier. In one embodiment, the processor 500 is configured to apply the MPR in response to using separate PAs (with separate LOs) for the plurality of carriers.

In one embodiment, channel bandwidth for determining the emissions requirements for the UE is aggregated from channel bandwidth of at least two carriers of the plurality of carriers and in-band emissions requirements apply to the aggregated bandwidth of the at least two carriers.

In one embodiment, the at least two carriers of the plurality of carriers use the same subcarrier spacing. In one embodiment, the at least two carriers of the plurality of carriers use different subcarrier spacing.

In one embodiment, an inner MPR region of the aggregated bandwidth comprises a number of resource blocks determined based on a ratio of the subcarrier spacing of a first carrier of the at least two carriers and the subcarrier spacing of a second carrier of the at least two carriers. In one embodiment, an inner MPR region for the UE is expanded based on the aggregated bandwidth of the at least two carriers.

In one embodiment, the processor 500 is configured to configure a UE for contiguous carrier aggregation for a plurality of carriers, determine an allowed MPR for the UE comprising an inner MPR region that is expanded relative to a single carrier MPR region for single carrier emissions requirements, determine a lower bound on a maximum configured power for a resource block allocation based on the allowed MPR, the resource block allocation within at least one of the plurality of carriers, and communicate the lower bound on the maximum configured power for the resource block allocation.

In one embodiment, the lower bound on the maximum configured power is used to determine a modulation and coding scheme for the resource block allocation. In one embodiment, the resource block allocation is confined to a lower frequency uplink carrier. In one embodiment, the resource block allocation is confined to an upper frequency uplink carrier.

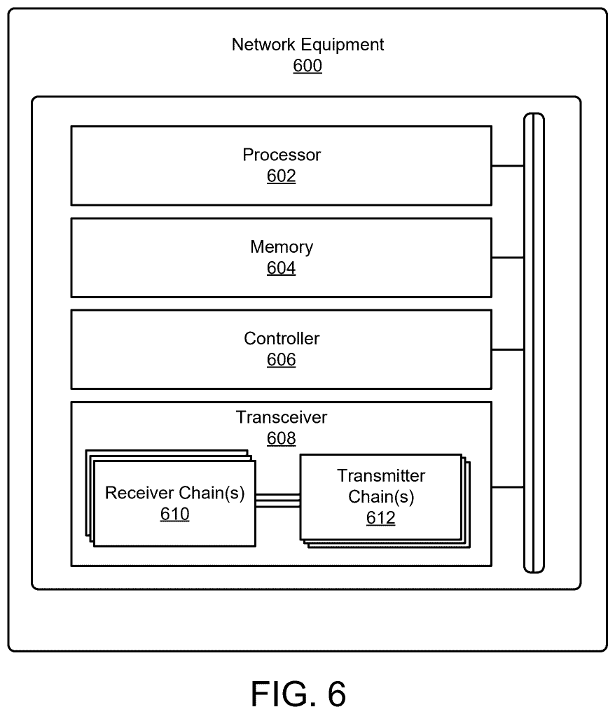

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein.

In one embodiment, the NE 600 is configured to configure a UE for contiguous carrier aggregation for a plurality of carriers, determine an allowed MPR for the UE comprising an inner MPR region that is expanded relative to a single carrier MPR region for single carrier emissions requirements, determine a lower bound on a maximum configured power for a resource block allocation based on the allowed MPR, the resource block allocation within at least one of the plurality of carriers, and communicate the lower bound on the maximum configured power for the resource block allocation.

In one embodiment, the lower bound on the maximum configured power is used to determine an appropriate modulation and coding scheme for the resource block allocation. In one embodiment, the resource block allocation is confined to a lower frequency uplink carrier. In one embodiment, the resource block allocation is confined to an upper frequency uplink carrier.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding and processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

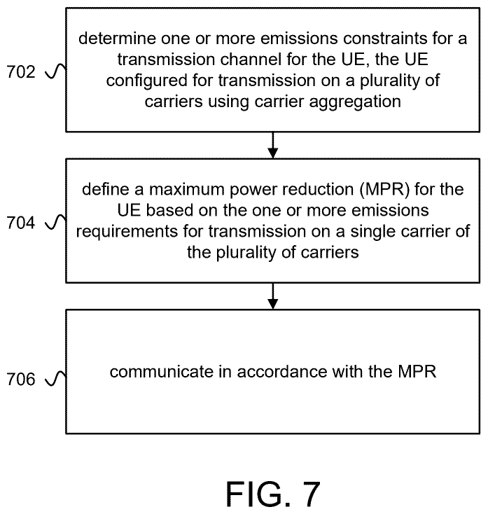

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may determine one or more emissions requirements for a transmission channel for a UE, the UE configured for transmission on a plurality of carriers using CA. The operations of 702 may be performed in accordance with examples as described herein. In some implementations, aspects of the operations of 702 may be performed by a UE as described with reference to FIG. 4.

At 704, the method may define an MPR for the UE based on the one or more emissions requirements for transmission on a single carrier of the plurality of carriers. The operations of 704 may be performed in accordance with examples as described herein. In some implementations, aspects of the operations of 704 may be performed by a UE as described with reference to FIG. 4.

At 706, the method may communicate in accordance with the MPR. The operations of 706 may be performed in accordance with examples as described herein. In some implementations, aspects of the operations of 706 may be performed by a UE as described with reference to FIG. 4.

It should be noted that the method described herein describes a possible implementation, and that the operations and the steps may be rearranged or otherwise modified and that other implementations are possible.

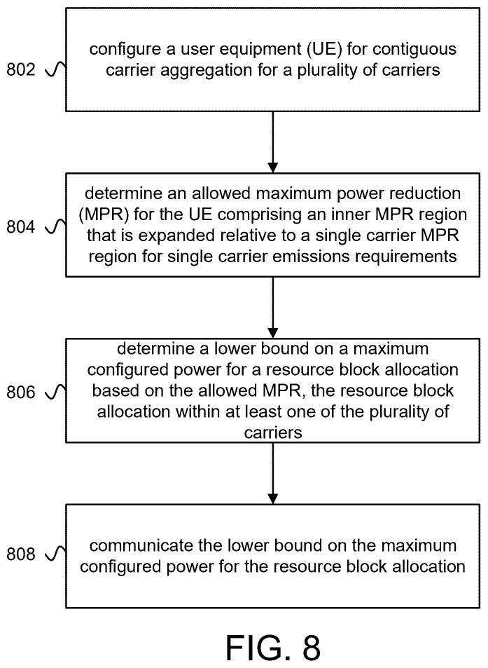

FIG. 8 illustrates a flowchart of a method in accordance with aspects of the present disclosure. The operations of the method may be implemented by a network equipment as described herein. In some implementations, the network equipment may execute a set of instructions to control the function elements of the network equipment to perform the described functions.

At 802, the method may configure a UE for contiguous carrier aggregation for a plurality of carriers. The operations of 802 may be performed in accordance with examples as described herein. In some implementations, aspects of the operations of 802 may be performed by a network equipment as described with reference to FIG. 6.

At 804, the method may determine an allowed MPR for the UE comprising an inner MPR region that is expanded relative to a single carrier MPR region for single carrier emissions requirements. The operations of 804 may be performed in accordance with examples as described herein. In some implementations, aspects of the operations of 804 may be performed by a network equipment as described with reference to FIG. 6.

At 806, the method may determine a lower bound on a maximum configured power for a resource block allocation based on the allowed MPR, the resource block allocation within at least one of the plurality of carriers. The operations of 806 may be performed in accordance with examples as described herein. In some implementations, aspects of the operations of 806 may be performed by a network equipment as described with reference to FIG. 6.

At 808, the method may communicate the lower bound on the maximum configured power for the resource block allocation. The operations of 808 may be performed in accordance with examples as described herein. In some implementations, aspects of the operations of 808 may be performed by a network equipment as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
determine one or more emissions requirements for a transmission channel for the UE, the UE configured for transmission on a plurality of carriers using carrier aggregation (CA);
define a maximum power reduction (MPR) for the UE based on the one or more emissions requirements for transmission on a single carrier of the plurality of carriers; and
communicate in accordance with the MPR.

2. The UE of claim 1, wherein the emissions requirements are for contiguous CA transmission and wherein the emissions requirements apply when transmitting on the single carrier of the plurality of carriers.

3. The UE of claim 2, wherein the at least one processor is configured to cause the UE to identify a set of resource block allocations for which an inner MPR applies, wherein an MPR region for the inner MPR is expanded relative to an MPR region for the single carrier for single carrier emissions requirements.

4. The UE of claim 3, wherein the single carrier of the plurality of carriers is a lower frequency uplink carrier.

5. The UE of claim 3, wherein the single carrier of the plurality of carriers is an upper frequency uplink carrier.

6. The UE of claim 1, wherein the at least one processor is configured to apply the MPR in response to using separate power amplifiers (PAs) with separate local oscillators (LOs) for the plurality of carriers.

7. The UE of claim 1, wherein channel bandwidth for determining the emissions requirements for the UE is aggregated from channel bandwidth of at least two carriers of the plurality of carriers and in-band emissions requirements apply to the aggregated bandwidth of the at least two carriers.

8. The UE of claim 7, wherein the at least two carriers of the plurality of carriers use the same subcarrier spacing.

9. The UE of claim 7, wherein the at least two carriers of the plurality of carriers use different subcarrier spacing.

10. The UE of claim 9, wherein an inner MPR region of the aggregated bandwidth comprises a number of resource blocks determined based on a ratio of the subcarrier spacing of a first carrier of the at least two carriers and the subcarrier spacing of a second carrier of the at least two carriers.

11. The UE of claim 7, wherein an inner MPR region for the UE is expanded based on the aggregated bandwidth of the at least two carriers.

12. A processor for wireless communication, comprising:
at least one controller coupled with at least one memory and configured to cause the processor to:
determine one or more emissions requirements for a transmission channel for a user equipment (UE), the UE configured for transmission on a plurality of carriers using carrier aggregation (CA);
define a maximum power reduction (MPR) for the UE based on the one or more emissions requirements for transmission on a single carrier of the plurality of carriers; and
communicate in accordance with the MPR.

13. The processor of claim 12, wherein the emissions requirements are for contiguous CA transmission and wherein the emissions requirements apply when transmitting on the single carrier of the plurality of carriers.

14. The processor of claim 13, wherein the at least one processor is configured to cause the UE to identify a set of resource block allocations for which an inner MPR applies, wherein an MPR region for the inner MPR is expanded relative to an MPR region for the single carrier for single carrier emissions requirements.

15. The processor of claim 14, wherein the single carrier of the plurality of carriers is a lower frequency uplink carrier.

16. A method of a user equipment (UE), comprising:
determining one or more emissions requirements for a transmission channel for the UE, the UE configured for transmission on a plurality of carriers using carrier aggregation (CA);
defining a maximum power reduction (MPR) for the UE based on the one or more emissions requirements for transmission on a single carrier of the plurality of carriers; and
communicating in accordance with the MPR.

17. A network equipment (NE) for wireless communication, comprising:
at least one memory; and
at least one processor coupled with the at least one memory and configured to cause the NE to:
configure a user equipment (UE) for contiguous carrier aggregation for a plurality of carriers;
determine an allowed maximum power reduction (MPR) for the UE comprising an inner MPR region that is expanded relative to a single carrier MPR region for single carrier emissions requirements;
determine a lower bound on a maximum configured power for a resource block allocation based on the allowed MPR, the resource block allocation within at least one of the plurality of carriers; and
communicate the lower bound on the maximum configured power for the resource block allocation.

18. The NE of claim 17, wherein the lower bound on the maximum configured power is used to determine a modulation and coding scheme for the resource block allocation.

19. The NE of claim 17, wherein the resource block allocation is confined to a lower frequency uplink carrier.

20. The NE of claim 17, wherein the resource block allocation is confined to an upper frequency uplink carrier.
